(19) United States
(12) Patent Application Publication
(10) Pub. No.: US 2026/0213189 A1
(43) Pub. Date: Jul. 23, 2026

(54) CATHODE ACTIVE MATERIAL FOR ANION BATTERY AND ANION BATTERY

(71) Applicant: TOYOTA JIDOSHA KABUSHIKI KAISHA, Toyota-shi, Aichi-ken (JP)

(72) Inventor: Hidenori MIKI, Hiratsuka-shi (JP)

(73) Assignee: TOYOTA JIDOSHA KABUSHIKI KAISHA, Toyota-shi, Aichi-ken (JP)

(21) Appl. No.: 19/448,588

(22) Filed: Jan. 14, 2026

(30) Foreign Application Priority Data
Jan. 21, 2025 (JP) 2025-008612
Oct. 10, 2025 (JP) 2025-172122

(51) Int. Cl. H01M 4/58; C01F 17/30

(52) U.S. Cl. CPC H01M 4/582; C01F 17/30; C01P 2002/72; C01P 2002/77; C01P 2006/40

(57) ABSTRACT

A cathode active material for an anion battery according to the present disclosure is a compound containing a lanthanoid, sulfur, and chlorine. An anion battery according to the present disclosure includes a cathode active material layer. The cathode active material layer contains the cathode active material of the present disclosure.

### CROSS-REFERENCE TO RELATED APPLICATION

This application claims priority to Japanese Patent Application No. 2025-008612 filed on Jan. 21, 2025, and to Japanese Patent Application No. 2025-172122 filed on Oct. 10, 2025. The disclosure of each of the above-identified applications, including the specification, drawings, and claims, is incorporated by reference herein in its entirety.

### BACKGROUND

### 1. Technical Field

The present disclosure relates to cathode active materials for anion batteries and anion batteries.

### 2. Description of Related Art

As disclosed in Japanese Unexamined Patent Application Publication No. 2022-126132 (JP 2022-126132 A) and Xiangyu Zhao et al., “Chloride Ion Battery: a new member in the rechargeable battery family,” Journal of Power Sources, Vol. 245 (2014), pp. 706-711, metal chlorides are known as cathode active materials for chloride-ion batteries, which are a type of anion battery.

### SUMMARY

An object of the present disclosure is to provide a novel cathode active material for an anion battery, and an anion battery containing such a cathode active material.

The present inventors have found that the above issue can be addressed by the following means.

### First Aspect

A cathode active material for an anion battery, the cathode active material being a compound containing a lanthanoid, sulfur, and chlorine.

### Second Aspect

The cathode active material according to the first aspect, wherein the lanthanoid is lanthanum.

### Third Aspect

The cathode active material according to the second aspect, wherein the compound is represented by the composition formula LaSCl.

### Fourth Aspect

An anion battery including a cathode active material layer, wherein the cathode active material layer contains the cathode active material according to any one of the first to third aspects.

### Fifth Aspect

The anion battery according to the fourth aspect, wherein the anion battery is a chloride-ion battery.

The present disclosure can provide a novel cathode active material for an anion battery, and an anion battery containing such a cathode active material.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic sectional view showing an example of an anion battery of the present disclosure;

FIG. 2 shows an X-ray diffraction (XRD) pattern of a cathode active material of Example 1;

FIG. 3 shows the crystal structure of LaSCl;

FIG. 4 shows charge-discharge curves of a battery of Example 1;

FIG. 5 shows an XRD pattern of a cathode active material of Example 2; and

FIG. 6 shows charge-discharge curves of a battery of Example 2.

### DETAILED DESCRIPTION OF EMBODIMENTS

An embodiment of the present disclosure will be described below in detail. The present disclosure is not limited to the embodiment described below, and various modifications may be made within the scope of the present disclosure.

### Cathode Active Material for Anion Battery

A cathode active material for an anion battery according to the present disclosure (hereinafter simply referred to as the “cathode active material of the present disclosure”) is a compound containing a lanthanoid, sulfur, and chlorine.

The inventors have found that a compound containing a lanthanoid, sulfur, and chlorine can function as a cathode active material for an anion battery.

The inventors also have found that such a cathode active material for an anode battery can increase the operating voltage of a battery.

Without intending to be bound by theory, it is believed that the reason why a cathode active material for an anion battery, which is a compound containing a lanthanoid, sulfur, and chlorine, can increase the operating voltage of a battery is as follows. First, since the cathode active material for an anion battery is a mixed-anion compound containing sulfide ions and chloride ions, the standard reduction potential is low. This facilitates the formation of lanthanoid ions that are readily oxidized, thereby increasing the potential of the cathode. Second, the compound containing a lanthanoid, sulfur, and chlorine has a crystal structure with many voids, thereby enabling effective incorporation of carrier anions such as chloride ions.

The lanthanoid is not particularly limited. It may be, for example, lanthanum or cerium, and may particularly be lanthanum. In this case, the compound containing a lanthanoid, sulfur, and chlorine may be a compound expressed by the composition formula LaSCl. The compound containing a lanthanoid, sulfur, and chlorine may be a compound expressed by the composition formula CeSCl. This can effectively increase the operating voltage of a battery.

The shape, size, etc. of the cathode active material of the present disclosure are not particularly limited, as long as it can function as a cathode active material for an anion battery.

The cathode active material of the present disclosure may be produced by the method described below or by another method.

### Method for Producing Cathode Active Material for Anion Battery

The cathode active material of the present disclosure can be produced by applying mechanical impact to a plurality of raw materials mixed at a predetermined molar ratio.

To produce a compound expressed by the composition formula LaSCl, the raw materials may be lanthanum chloride (LaCl₃) and lanthanum sulfide (La₂S₃).

To produce a compound expressed by the composition formula CeSCl, the raw materials may be cerium chloride (CeCl₃) and cerium sulfide (Ce₂S₃).

The molar ratio of the raw materials is not particularly limited. In the case of producing compounds expressed by the composition formulas LaSCl and CeSCl, the molar ratio of the raw materials may be, for example, LaCl₃/La₂S₃=1/1 and CeCl₃/Ce₂S₃=1/1, respectively. This facilitates the production of compounds expressed by the composition formulas LaSCl and CeSCl.

Examples of methods for applying mechanical impact to the raw materials include mechanochemical methods. Specifically, examples include mixing the raw materials using a ball mill. The operating mode of the ball mill may be, for example, planetary, vibratory, or rotary. Using a planetary ball mill enables efficient mixing of the raw materials. This process may be carried out under an inert gas atmosphere.

When the raw materials are mixed using a planetary ball mill, the rotation speed of the turntable, the mixing time, etc. are not particularly limited.

### Cathode Mixture for Anion Battery

A cathode mixture for an anion battery contains the cathode active material of the present disclosure, and may optionally further contain a solid electrolyte, a conductive additive, etc.

In the present disclosure, the term “cathode mixture” refers to a composition that can form a cathode active material layer either by itself or in combination with other components.

### Cathode Active Material

The cathode mixture for an anion battery contains the cathode active material of the present disclosure. For details of the cathode active material of the present disclosure, reference may be made to the description above.

The cathode active material contained in the cathode mixture may be composed of the cathode active material of the present disclosure, or may be a combination of the cathode active material of the present disclosure and another cathode active material. In particular, the cathode active material contained in the cathode mixture may be composed of the cathode active material of the present disclosure.

The cathode active material other than the cathode active material of the present disclosure is not particularly limited. For example, when the anion battery of the present disclosure is a chloride-ion battery, the cathode active material may be a metal chloride. The metal chloride is not particularly limited, and may be, for example, a post-transition metal chloride such as bismuth chloride (BiCl₃), gallium chloride (GaCl₃), or indium chloride (InCl₃); a noble metal chloride such as copper chloride (CuCl) or silver chloride (AgCl); a chloride of an iron-group metal such as nickel chloride (NiCl₂), cobalt chloride (CoCl₂), or iron chloride (FeCl₂); vanadium chloride (VCl₃); or any other metal chloride known as a cathode active material for chloride-ion batteries.

The content of the cathode active material in the cathode mixture may be, for example, 1 mass % or more, 5 mass % or more, 10 mass % or more, 15 mass % or more, 20 mass % or more, 25 mass % or more, or 30 mass % or more, and may be 100 mass % or less, 80 mass % or less, 60 mass % or less, 50 mass % or less, 45 mass % or less, 40 mass % or less, 35 mass % or less, or 30 mass % or less. This content may be 10 mass % or more and 50 mass % or less, 15 mass % or more and 45 mass % or less, or 20 mass % or more and 40 mass % or less.

The shape, size, etc. of the cathode active material are not particularly limited, as long as it can function as a cathode active material for an anion battery.

### Solid Electrolyte

The cathode mixture may contain a solid electrolyte. The solid electrolyte assists in the conduction of anions as carrier ions.

For example, when the anion battery of the present disclosure is a chloride-ion battery, the solid electrolyte is not particularly limited, and may be, for example, at least one selected from tin chloride (SnCl₂), strontium chloride (SrCl₂), barium chloride (BaCl₂), and the like.

The solid electrolyte may be any of the above-mentioned chlorides doped with potassium (K). For example, it may be Sr₁₋ₓKₓC₂₋ₓ (0<x≤0.1).

Sr₁₋ₓKₓC₂₋ₓ (0<x≤0.1) can be produced by, for example, applying mechanical impact to strontium chloride (SrCl₂) and potassium chloride (KCl) mixed at a predetermined molar ratio.

Such a method may be, for example, a mechanochemical method. Specifically, the raw materials may be mixed using a ball mill. The operating mode of the ball mill may be, for example, planetary, vibratory, or rotary. Using a planetary ball mill enables efficient mixing of the raw materials. This process may be carried out under an inert gas atmosphere.

When the raw materials are mixed using a planetary ball mill, the rotation speed of the turntable is not particularly limited. For example, it may be 300 rpm or more, 400 rpm or more, 500 rpm or more, or 600 rpm or more, and may be 1000 rpm or less, 900 rpm or less, 800 rpm or less, 700 rpm or less, or 600 rpm or less.

When the raw materials are mixed using a planetary ball mill, the mixing time is not particularly limited. For example, it may be 0.5 hours or more, one hour or more, two hours or more, or three hours or more, and may be 10 hours or less, eight hours or less, six hours or less, four hours or less, or three hours or less.

The solid electrolyte may be, for example, CsSnCl₃, or CsSn₁₋ₓYₓCl₃₊ₓ (0<x≤0.1) in which CsSnCl₃ is doped with yttrium (Y).

CsSnCl₃ can be produced by, for example, applying mechanical impact to cesium chloride (CsCl) and tin chloride (SnCl₂) mixed at a predetermined molar ratio. CsSn₁₋ₓYₓCl₃₊ₓ (0<x≤0.1) can be produced by, for example, applying mechanical impact to cesium chloride (CsCl), tin chloride (SnCl₂), and yttrium chloride (YCl₃) mixed at a predetermined molar ratio.

Such a method may be, for example, a mechanochemical method. Specifically, the raw materials may be mixed using a ball mill. The operating mode of the ball mill may be, for example, planetary, vibratory, or rotary. Using a planetary ball mill enables efficient mixing of the raw materials. This process may be carried out under an inert gas atmosphere.

When the raw materials are mixed using a planetary ball mill, the rotation speed of the turntable is not particularly limited. For example, it may be 300 rpm or more, 400 rpm or more, 500 rpm or more, or 600 rpm or more, and may be 1000 rpm or less, 900 rpm or less, 800 rpm or less, 700 rpm or less, or 600 rpm or less.

When the raw materials are mixed using a planetary ball mill, the mixing time is not particularly limited, and may be, for example, one hour or more, three hours or more, five hours or more, or 10 hours or more, and may be 30 hours or less, 20 hours or less, 15 hours or less, or 10 hours or less.

The content of the solid electrolyte in the cathode mixture may be, for example, 1 mass % or more, 10 mass % or more, 30 mass % or more, 50 mass % or more, or 60 mass % or more, and may be 99 mass % or less, 90 mass % or less, 80 mass % or less, 70 mass % or less, or 60 mass % or less.

The shape, size, etc. of the solid electrolyte are not particularly limited, as long as it can function as a solid electrolyte for an anion battery.

### Conductive Additive

The cathode mixture may contain a conductive additive. The conductive additive is not particularly limited, as long as it is electronically conductive.

The conductive additive may be, for example, a carbon material, an elemental metal, a metal compound, or a combination thereof.

The carbon material may be, for example, at least one selected from: carbon black such as acetylene black, Ketjen black, or furnace black; graphite powder; and fibrous carbon materials such as vapor-grown carbon fibers (VGCFs).

The content of the conductive additive in the cathode mixture is not particularly limited, and may be, for example, 1 mass % or more, 5 mass % or more, or 10 mass % or more, and may be 30 mass % or less, 20 mass % or less, or 10 mass % or less.

### Other Components

The cathode mixture may or may not contain components other than those described above. Such components are not particularly limited, and may include, for example, a binder. The binder may be any material that is chemically and electrically stable in an anion battery. The types, contents, etc. of such components can be determined as appropriate.

### Method for Producing Cathode Mixture for Anion Battery

The cathode mixture for an anion battery can be produced by applying mechanical impact to raw materials.

Examples of methods for applying mechanical impact to the raw materials include mixing the raw materials using a ball mill. The operating mode of the ball mill may be, for example, planetary, vibratory, or rotary. Using a planetary ball mill enables efficient mixing of the raw materials. This process may be carried out under an inert gas atmosphere.

When the raw materials are mixed using a planetary ball mill, the rotation speed of the turntable is not particularly limited, and may be, for example, 10 rpm or more, 30 rpm or more, 50 rpm or more, or 100 rpm or more, and may be 500 rpm or less, 300 rpm or less, 200 rpm or less, or 100 rpm or less.

When the raw materials are mixed using a planetary ball mill, the mixing time is not particularly limited, and may be, for example, one hour or more, three hours or more, five hours or more, or 10 hours or more, and may be 30 hours or less, 20 hours or less, 15 hours or less, or 10 hours or less.

### Anion Battery

The anion battery of the present disclosure includes a cathode active material layer, and the cathode active material layer contains the cathode active material of the present disclosure. Since the anion battery contains the cathode active material of the present disclosure, its operating voltage is high.

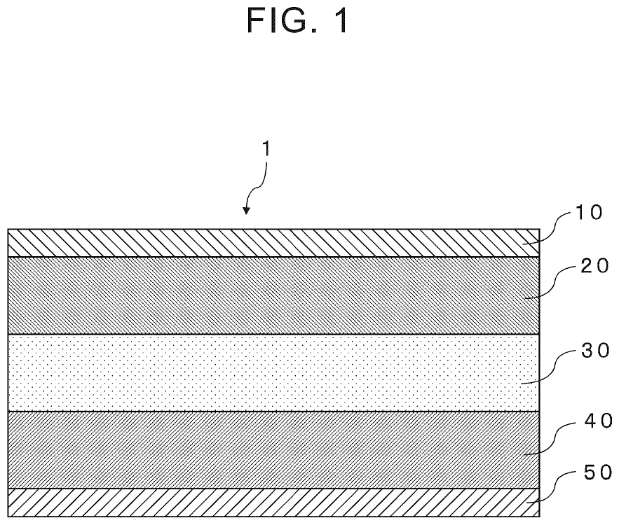

As illustrated in FIG. 1, an anion battery 1 of the present disclosure may include a cathode active material layer 20, an electrolyte layer 30, and an anode active material layer 40 in this order.

The anion battery of the present disclosure may be a liquid battery or a solid-state battery, and may particularly be a solid-state battery. In the present disclosure, the term “solid-state battery” refers to a battery that uses at least a solid electrolyte as the electrolyte. Accordingly, a solid-state battery may use a combination of a solid electrolyte and a liquid electrolyte as the electrolyte. The solid-state battery may be an all-solid-state battery, that is, a battery that uses a solid electrolyte as the electrolyte.

The anion battery may be a primary battery or a secondary battery, and may particularly be a secondary battery.

The anion battery is not particularly limited. It may be, for example, a fluoride-ion battery or a chloride-ion battery, and may particularly be a chloride-ion battery.

The anion battery may be, for example, of a coin type, a laminate (pouch) type, a cylindrical type, or a prismatic type.

The anion battery can be manufactured by forming each of the above layers by a dry process or a wet process.

The anion battery of the present disclosure can be suitably used in at least one type of vehicle selected from a hybrid electric vehicle (HEV), a plug-in hybrid electric vehicle (PHEV), and a battery electric vehicle (BEV).

The following description illustrates, by way of example, the components of the anion battery of the present disclosure in the case where the anion battery of the present disclosure is an all-solid-state chloride-ion battery.

### Cathode Active Material Layer

The cathode active material layer contains the cathode active material of the present disclosure. For details of the cathode active material of the present disclosure, reference may be made to the description above.

The cathode active material layer may be a compact of the cathode mixture containing the cathode active material of the present disclosure.

The shape of the cathode active material layer is not particularly limited. The cathode active material layer may be, for example, in the form of a sheet having a substantially flat surface.

The thickness of the cathode active material layer is not particularly limited, as long as it is an appropriate thickness according to the configuration of the anion battery etc. The thickness of the cathode active material layer may be, for example, 100 nm or more and 1 mm or less.

### Electrolyte Layer

The electrolyte layer may be a solid electrolyte layer containing a solid electrolyte. For details of the solid electrolyte, reference may be made to the description above.

The shape of the electrolyte layer is not particularly limited. The electrolyte layer may be, for example, in the form of a sheet having a substantially flat surface.

The thickness of the electrolyte layer is not particularly limited, as long as it is an appropriate thickness according to the configuration of the anion battery etc. The thickness of the electrolyte layer may be, for example, 100 nm or more and 1 mm or less.

### Anode Active Material Layer

The anode active material layer contains an anode active material, and may optionally further contain a solid electrolyte, a conductive additive, etc.

The anode active material is not particularly limited, as long as it has a lower potential than the cathode active material. Examples of such active materials include elemental metals such as lead (Pb) and tin (Sn), alloys, oxides thereof, and chlorides thereof.

The anode active material may be, for example, CsSnCl₃, or CsSn₁₋ₓYₓCl₃₊ₓ (0<x≤0.1) in which CsSnCl₃ is doped with yttrium (Y).

CsSnCl₃ can be produced by, for example, applying mechanical impact to cesium chloride (CsCl) and tin chloride (SnCl₂) mixed at a predetermined molar ratio.

Such a method may be, for example, a mechanochemical method. Specifically, the raw materials may be mixed using a ball mill. The operating mode of the ball mill may be, for example, planetary, vibratory, or rotary. Using a planetary ball mill enables efficient mixing of the raw materials. This process may be carried out under an inert gas atmosphere.

When the raw materials are mixed using a planetary ball mill, the rotation speed of the turntable is not particularly limited. For example, it may be 300 rpm or more, 400 rpm or more, 500 rpm or more, or 600 rpm or more, and may be 1000 rpm or less, 900 rpm or less, 800 rpm or less, 700 rpm or less, or 600 rpm or less.

When the raw materials are mixed using a planetary ball mill, the mixing time is not particularly limited, and may be, for example, one hour or more, three hours or more, five hours or more, or 10 hours or more, and may be 30 hours or less, 20 hours or less, 15 hours or less, or 10 hours or less.

For details of the solid electrolyte and the conductive additive, reference may be made to the description above.

The shape of the anode active material layer is not particularly limited. The anode active material layer may be, for example, in the form of a sheet having a substantially flat surface.

The thickness of the anode active material layer is not particularly limited, as long as it is an appropriate thickness according to the configuration of the anion battery etc. The thickness of the anode active material layer may be, for example, 100 nm or more and 1 mm or less.

### Other Configurations

As shown in FIG. 1, the anion battery of the present disclosure may further include a cathode current collector layer 10 and an anode current collector layer 50. The materials, shapes, thicknesses, etc. of the cathode current collector layer and the anode current collector layer are not particularly limited, as long as they can function as current collector layers for an anion battery. The anion battery of the present disclosure may further include other components.

### EXAMPLE 1

### Synthesis of Cathode Active Material for Anion Battery

Lanthanum chloride (LaCl₃) and lanthanum sulfide (La₂S₃) were weighed in a molar ratio of 1:1, and a cathode active material was obtained by a mechanochemical method using a ball mill.

### Fabrication of Chloride-Ion Battery

The obtained cathode active material, potassium (K)-doped SrCl₂ (Sr_{0.97}K_{0.03}Cl_{1.97} as a solid electrolyte, and vapor grown carbon fibers (VGCFs) (manufactured by Showa Denko K.K.) as a conductive additive were weighed in a mass ratio of 30:60:10. The total amount of the raw materials used was 10 mg. These raw materials were mixed at 100 rpm for 10 hours using a ball mill to obtain a cathode mixture. The cathode active material layer was then formed by compacting the cathode mixture.

Sr_{0.97}K_{0.03}Cl_{1.97} as the solid electrolyte was synthesized by mixing strontium chloride (SrCl₂) and potassium chloride (KCl) at 600 rpm for three hours using a ball mill.

The solid electrolyte layer was formed by compacting 100 mg of Sr_{0.97}K_{0.03}Cl_{1.97} as the solid electrolyte.

The anode active material layer was formed by placing a tin (Sn) foil on one side (where the anode current collector layer would later be disposed) of a layer formed using 50 mg of CsSnCl₃. CsSnCl₃ was synthesized by weighing cesium chloride (CsCl) and tin chloride (SnCl₂) in a predetermined molar ratio, and mixing them at 600 rpm for 10 hours using a ball mill.

An all-solid-state chloride-ion battery was fabricated by stacking the cathode current collector layer, the cathode active material layer, the solid electrolyte layer, the anode active material layer, and the anode current collector layer in this order.

### Evaluation

### XRD Measurement

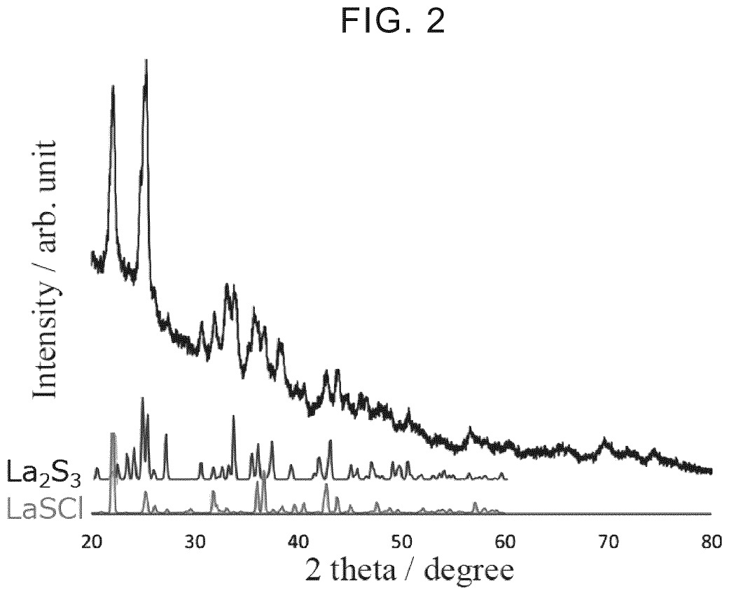

X-ray diffraction (XRD) measurement was performed on the sample obtained in the process of synthesizing the cathode active material for an anion battery. The XRD measurement was carried out using an Ultima IV X-ray diffraction system (manufactured by Rigaku Holdings Corporation) under an inert gas atmosphere by the focusing method with CuKα radiation at a tube voltage of 40 kV and a tube current of 40 mA. The sample was sealed in an airtight sample holder under an argon atmosphere and measured without exposure to air. A glass sample holder was used as the substrate for mounting the sample. The obtained XRD pattern is shown in FIG. 2.

As shown in FIG. 2, peaks different from those of the starting material La₂S₃ present in the sample were observed in the XRD pattern, and these peaks were identified as LaSCl.

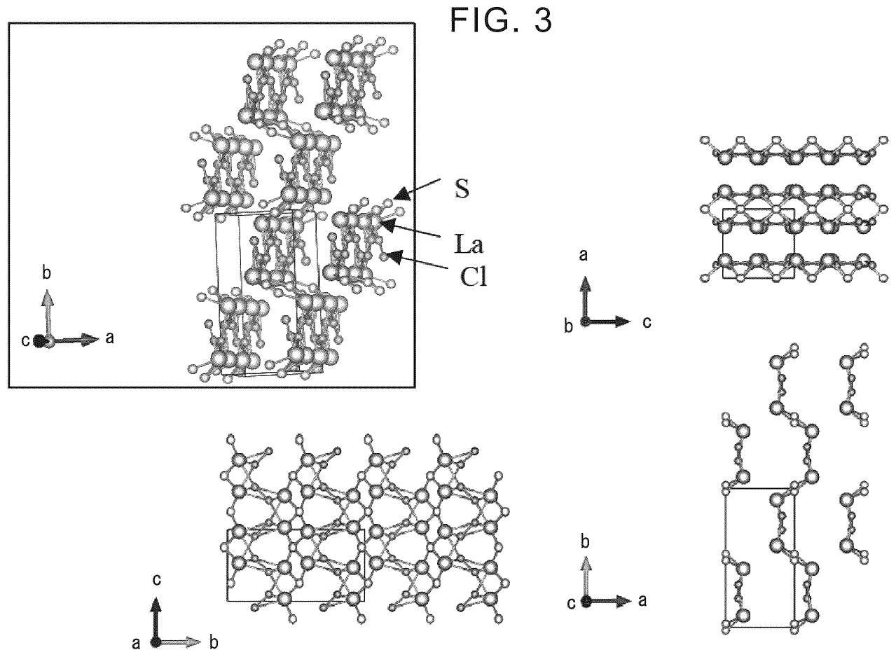

FIG. 3 shows the crystal structure of LaSCl. As shown in FIG. 3, it was confirmed that there were many voids in this crystal structure.

### Charge-Discharge Test

For the chloride-ion battery of Example 1, a charge-discharge test was performed in a sealed container under vacuum at a test temperature of 200° C. and a current density of 0.03 mA/cm². Constant-voltage charging was carried out under the following charge termination conditions: a maximum voltage of 2.0 V and a minimum current of 0.001 mA/cm². The discharge termination condition was a minimum voltage of −0.5 V. The charge-discharge test was performed using an electrochemical measurement system equipped with a frequency response analyzer (VMP-300 high-performance electrochemical measurement system, manufactured by BioLogic).

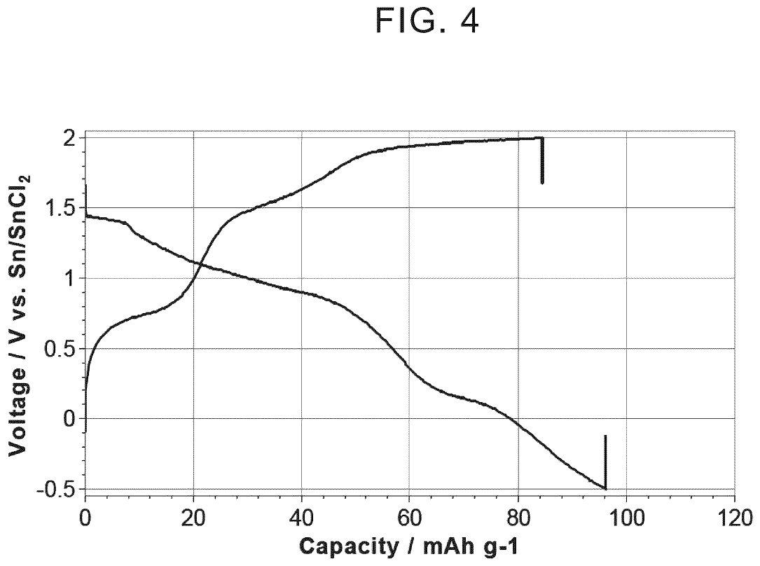

The charge-discharge curves of the battery of Example 1 are shown in FIG. 4. As shown in FIG. 4, in the battery of Example 1, a discharge reaction at a high potential exceeding 1.0 V vs. Sn/SnCl₂ was confirmed.

As described in Xiangyu Zhao et al., “Chloride Ion Battery: a new member in the rechargeable battery family,” Journal of Power Sources, Vol. 245(2014), pp. 706-711, the operating voltage of a chloride-ion battery using BiCl₃ as the cathode active material and lithium metal as the anode active material was 2.89 V, and the operating voltage of a chloride-ion battery using CuCl₂ as the cathode active material and lithium metal as the anode active material was 3.07 V. In contrast, the operating voltage of a battery that was the same as these batteries except that LaSCl was used as the cathode active material was 3.5 V or higher. That is, it was confirmed that the operating voltage of the chloride-ion battery containing the cathode active material of the present disclosure was greater than those of the batteries described in Xiangyu Zhao et al., “Chloride Ion Battery: a new member in the rechargeable battery family,” Journal of Power Sources, Vol. 245 (2014), pp. 706-711.

When a charge-discharge test was similarly carried out using La₂S₃, which was the starting material, as the cathode active material, no capacity was observed, and it was confirmed that La₂S₃ did not contribute to the electrode reaction.

### EXAMPLE 2

### Synthesis of Cathode Active Material for Anion Battery

Cerium chloride (CeCl₃) and cerium sulfide (Ce₂S₃) were weighed in a molar ratio of 1:1, and a cathode active material was obtained by a mechanochemical method using a ball mill.

### Fabrication of Chloride-ion Battery

The obtained cathode active material, yttrium (Y)-doped CsSnCl₃ (CsSn_{0.95}Y_{0.05}Cl_{3.05}) as a solid electrolyte, and vapor grown carbon fibers (VGCFs) (manufactured by Showa Denko K.K.) as a conductive additive were weighed in a mass ratio of 30:60:10. The total amount of the raw materials used was 10 mg. These raw materials were mixed at 100 rpm for 10 hours using a ball mill to obtain a cathode mixture. The cathode active material layer was then formed by compacting the cathode mixture.

CsSn_{0.95}Y_{0.05}Cl_{3.05} as the solid electrolyte was synthesized by weighing cesium chloride (CsCl), tin chloride (SnCl₂), and yttrium chloride (YCl₃) in a predetermined molar ratio, and mixing them at 600 rpm for 10 hours using a ball mill.

The solid electrolyte layer was formed by compacting 100 mg of CsSn_{0.95}Y_{0.05}Cl_{3.05} as the solid electrolyte.

The anode active material layer was formed by placing an Sn foil on one side (where the anode current collector layer would later be disposed) of a layer formed using Sn and 50 mg of CsSn_{0.95}Y_{0.05}Cl_{3.05}.

An all-solid-state chloride-ion battery was fabricated by stacking the cathode current collector layer, the cathode active material layer, the solid electrolyte layer, the anode active material layer, and the anode current collector layer in this order.

### Evaluation

### XRD Measurement

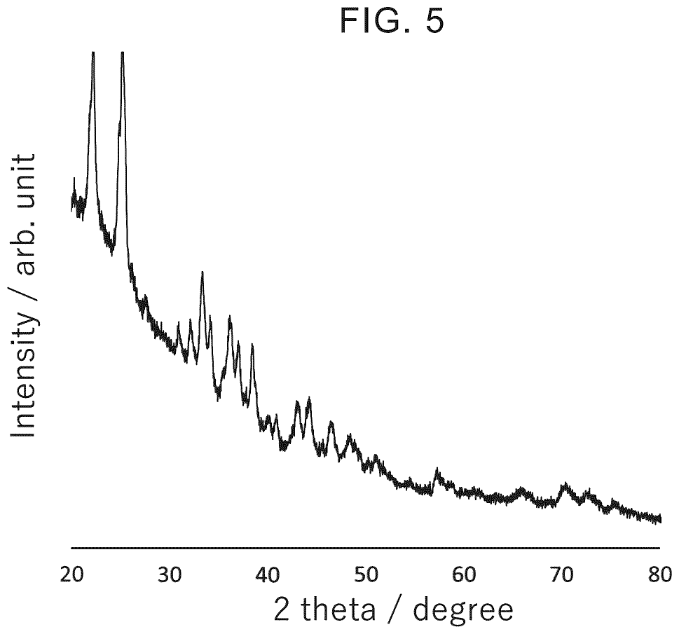

XRD measurement was performed on the sample obtained in the process of synthesizing the cathode active material for an anion battery. The XRD measurement was performed in the same manner as in Example 1. The obtained XRD pattern is shown in FIG. 5.

Peaks different from those of the starting material Ce₂S₃ present in the sample were observed in the XRD pattern, and these peaks were identified as CeSCl.

### Charge-Discharge Test

For the chloride-ion battery of Example 2, a charge-discharge test was performed in the same manner as in Example 1.

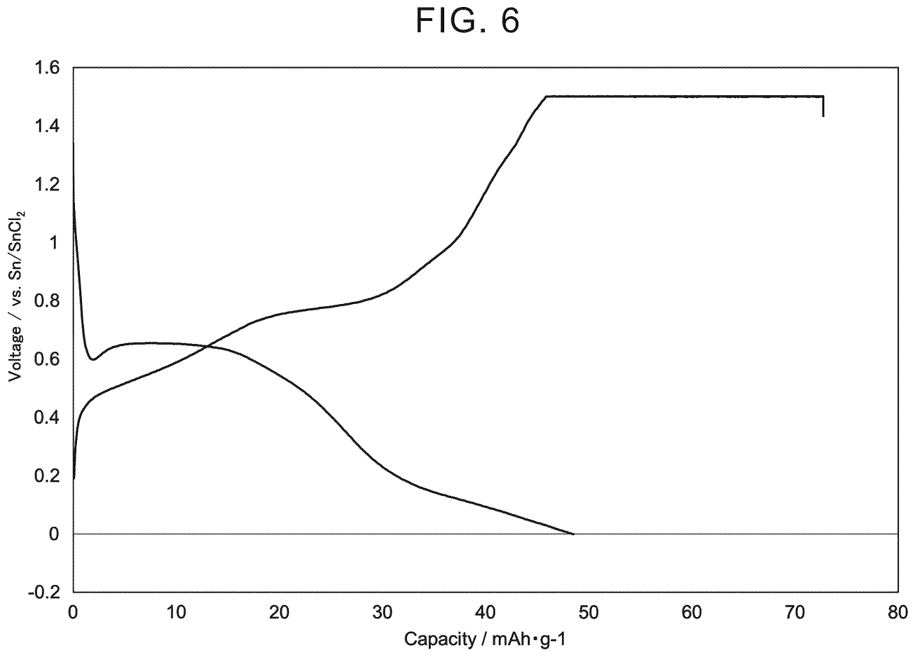

The obtained charge-discharge curves are shown in FIG. 6. As shown in FIG. 6, in the battery of Example 2, a discharge reaction at a high potential exceeding 1.0 V vs. Sn/SnCl₂ was confirmed.

What is claimed is:

1. A cathode active material for an anion battery, the cathode active material being a compound containing a lanthanoid, sulfur, and chlorine.

2. The cathode active material according to claim 1, wherein the lanthanoid is lanthanum.

3. The cathode active material according to claim 2, wherein the compound is represented by a following composition formula: LaSCl.

4. An anion battery comprising a cathode active material layer, wherein the cathode active material layer contains the cathode active material according to claim 1.

5. The anion battery according to claim 4, wherein the anion battery is a chloride-ion battery.
